(19) United States
(12) Patent Application Publication
(10) Pub. No.: US 2016/0103858 A1
(43) Pub. Date: Apr. 14, 2016

(54) DATA MANAGEMENT SYSTEM COMPRISING A TRIE DATA STRUCTURE, INTEGRATED CIRCUITS AND METHODS THEREFOR

(71) Applicants: ADI KATZ, RAMAT GAN (IL); EVGENI GINZBURG, PETAH TIKVA (IL)

(72) Inventors: ADI KATZ, RAMAT GAN (IL); EVGENI GINZBURG, PETAH TIKVA (IL)

(73) Assignee: FREESCALE SEMICONDUCTOR, INC., Austin, TX (US)

(21) Appl. No.: 14/512,528

(22) Filed: Oct. 13, 2014

(51) Int. Cl. G06F 17/30

(52) U.S. Cl. CPC G06F 17/30292; G06F 17/30424

(57) ABSTRACT

A data management system comprises a trie data structure. The trie data structure comprises a plurality of interconnected nodes wherein at least a portion of said plurality of interconnected nodes is configured as parent nodes and child nodes, wherein at least one child node comprises an identifier of its parent node.

### FIELD OF THE INVENTION

The field of this invention relates to a data management system comprising a trie data structure, integrated circuits and methods for modifying, searching and/or accessing data within the trie data structure.

### BACKGROUND OF THE INVENTION

In computer science, a data structure is a particular way of organizing data in a computer so that the data can be used and stored and accessed efficiently. Different kinds of data structures are suited to different kinds of applications, and some are often highly specialized to specific tasks. Data structures provide a means to manage large amounts of data efficiently, such as large databases and internet indexing services. Usually, efficient data structures are a key factor in designing efficient algorithms that use large amounts of data. Some formal design methods and programming languages emphasize data structures, rather than algorithms, as the key organizing factor in software design. Storing and retrieving is carried out on data stored in both main memory and in secondary memory.

One known data structure in computer science is termed a trie, sometimes referred to as a radix tree, a digital tree or a prefix tree as they can be searched by prefixes. A trie is an ordered multi-way tree data structure that is used to store strings over an alphabet. Unlike a binary search tree, no node in the tree stores the key associated with that node. Instead, its position in the tree shows what key it is associated with. Thus, a trie is a tree data structure that allows strings with similar character prefixes to use the same prefix data and only the tails of the string are used to distinguish separate nodes or data.

In a trie, each node contains an array of pointers, one pointer for each character in the alphabet. All the descendants of a node have a common prefix of the string associated with that node. Contrary to most binary-trees that would be used for sorting strings (i.e. trees that would store entire words in their nodes), each node of a trie holds a single character and has a maximum fan-out equal to the length of the alphabet, which in most cases uses an alphabet of 26 characters. Hence, the nodes of a trie would have a maximum fan-out of 26.

One character of the string is stored at each level of the tree, with the first character of the string stored at the root. In this manner, within a trie, words with the same stem (prefix) share the memory area that corresponds to the stem.

Referring to FIG. 1, a known trie structure 100 and a known node 150 are illustrated. As can be seen from the trie structure 100, a node 102, which can be considered as a node father, has a descendent, child ‘t’ 104, together with other children ‘a’ and T. Child T 104, in turn has a descendent, child ‘te’ 106 with a common prefix associated with node T 104. Further, descendants, i.e. children ‘tea’ 108, ‘ted’ 110 and ‘ten’ 112, of node ‘te’ 106 also have common prefixes with node ‘te’ 106. In this manner, each internal node may comprise a variable number of children, with each identified by its own character number as part of a common prefix.

Referring now to the content of a node 150, individual nodes 150 may contain an internal value, and a father pointer per child, e.g. pointer 1 to child ‘n’ at node 112, pointer 2 to child ‘d’ at node 110, and pointer 3 to child ‘a’ at node 108. Each node is of a variable size. Any data lookup table or searching technique that uses a trie structure typically involves managing such pointers and memory allocations, which adds to the complexity and processing resources that are required.

U.S. Pat. No. 7,523,171B2, titled “Multidimensional hashed tree based URL matching engine using progressive hashing”, describes a multidimensional hash table for a hashed-tree arrangement whereby URLs are progressively hashed character by character.

There exists a need for a more efficient data structure and method of searching in terms of performance and memory management.

### SUMMARY OF THE INVENTION

The present invention provides a data management system comprising a trie data structure, integrated circuits and methods of modifying, searching and/or accessing data within the trie data structure, as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a known trie structure.

FIG. 2 illustrates an example block diagram of a data management system that uses trie data structures, according to some examples of the invention.

FIG. 3 illustrates a simplified example block diagram of an architecture that uses a trie data structure, according to some examples of the invention.

FIG. 4 illustrates how a hash table is used for going down the trie data structure, according to some examples of the invention.

FIG. 5 illustrates how a hash table is used for going up the trie data structure, according to some examples of the invention.

FIG. 6 illustrates an insert flow chart, according to some examples of the invention.

FIG. 7 illustrates a search flow chart, according to some examples of the invention.

### DETAILED DESCRIPTION

Because the illustrated embodiments of the present invention may, for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

A known technique that uses trie data structures implements a trie using a multidimensional hash table because each node stage needs to be managed to avoid hash collisions. Hence, such a multidimensional hash table can be dynamically updated to point to the existing children of that node. However, such a multidimensional hash table does not point to the father node/identifier (ID).

In contrast, examples of the invention describe mechanisms that only require use of a single non-multidimensional hash table, within a pointer that points to the father node/identifier (ID). The non-multidimensional hash table is built from a number of hash entries. A hash entry contains a key that is used to look for it so that it can be identified. In examples herein described each hash entry is a node, which contains the key.

In some examples herein described, the terms father and father node may be used interchangeably with the terms parent and parent node.

In some examples, each node may be provided with an internal value that is a unique ID. In this manner, the unique ID may be used in order to access the node's children. In some examples, a child node may be inserted into a hash table using its father's unique ID and its child number. In this manner, a father chain may be created to trace back through father nodes to the source father node. In some examples, the data structure may be of a fixed size in order to simplify the implementation, as known variable size data structures are more difficult to manage due to the size of the data structure being dynamically changed when the trie is updated. In some examples, a fixed size data structure may be easier to manage because the memory partition is known apriori and, hence, a database of free buffers is simpler to implement. In implementing a variable size data structure, it is important to know the buffer sizes so that buffers can be merged into bigger buffers, which adds to the complexity.

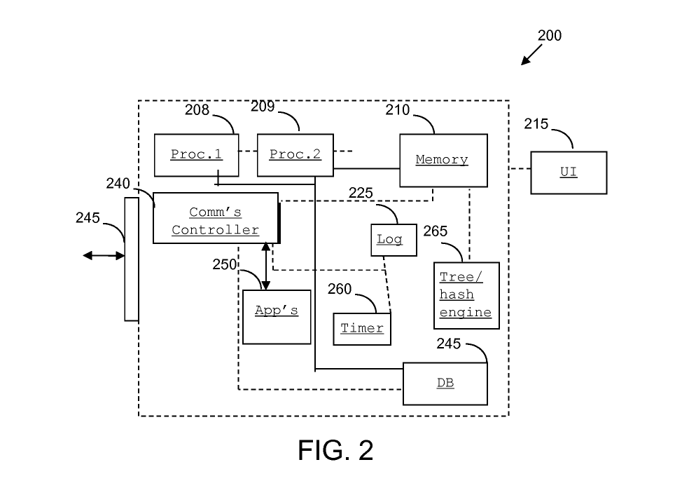

Referring now to FIG. 2, a detailed example block diagram of a data management system 200 that employs a trie data structure is illustrated. The data management system 200 comprises a trie data structure comprising a plurality of interconnected nodes, wherein at least a portion of said plurality of interconnected nodes is configured as parent nodes and and/or a portion of said plurality of interconnected nodes configured as child nodes. At least one child node comprises an identifier of its parent node. In some examples, the identifier may be a unique identifier. In some examples, the identifier of the parent node may be contained in a unique identifier of the child node, or in a pointer.

In some examples, the data management system 200 comprises one or more processors 208, 209, which may be configured to run, for example, a software program from an operating system. In some examples, an operating system may load a program into a computer memory 210. In examples herein described, the memory 210 may be operably coupled to a tree/hash engine 265 that may be used for accessing or modifying nodes and/or data and is configured to store trie-based structures of data.

In examples, the tree/hash engine 265 uses hash values that have been modified to include a father node's unique ID and its child number, in order to facilitate accessing and modifying data points, in directions that are both up and/or down the trie data structure. In this manner, a father node (e.g. a parent node) may be accessed using the key from the hash lookup table and a present key hash value. A hash value (or simply ‘hash’) is a number that is generated from a string of text. The hash is substantially smaller than the text itself, and is generated by a formula in such a way that it is extremely unlikely that some other text will produce the same hash value.

In some examples, a hash table (or in some examples a hash map) may also be used and is a data structure that associates keys with, say, such hash values. A primary operation of a hash table is that it supports a lookup table given a key (e.g. a father node's ID plus a child node ID) and links a corresponding value (e.g. validity on the existence of a string/prefix). The lookup table access works by transforming the key using a hash function into a hash number that the hash table uses to locate the desired value, or node. Often, hash values are used for accessing data records or for security purposes. The non-multidimensional hash table is built from a number of hash entries. A hash entry contains a key that is used to look for it so that it can be identified. In examples herein described each hash entry is a node, which contains the key.

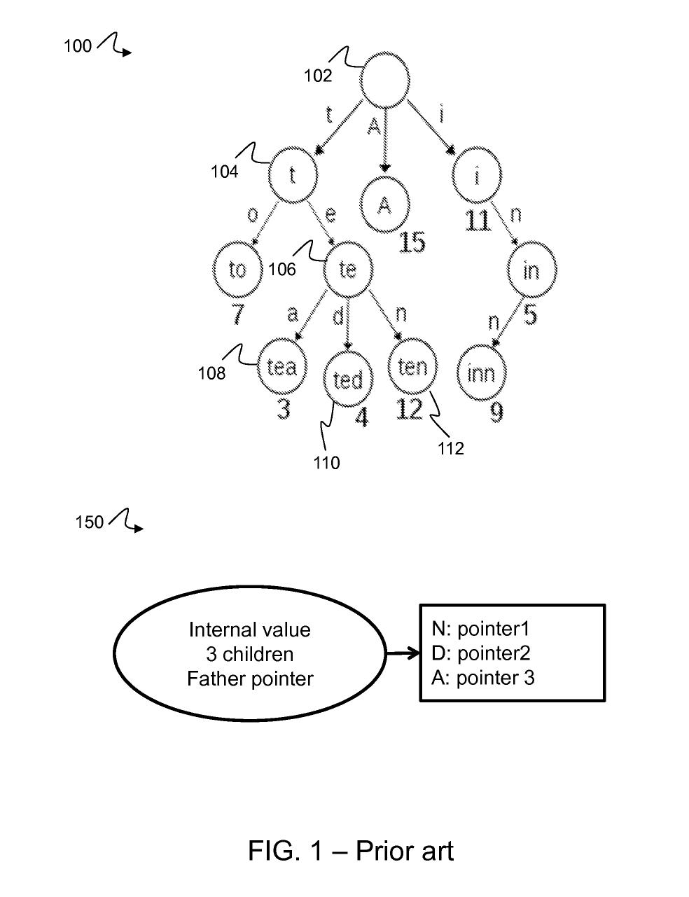

Table 1 illustrates an example of a single (non-multidimensional) hash table that may embed the trie of FIG. 1:

TABLE 1

| Node ID | Hash key |
|---|---|
| 102 | Root |
| 104 | 102, t |
| 106 | 104, e |
| 108 | 106, a |
| 110 | 106, d |
| 112 | 106, n |

In some examples, the data management system 200 may further comprise a communications controller 240, operably coupled to a communications interface 245, for interfacing with external networks, such as the Internet. The data management system 200 may further comprise an optional user interface (UI) 215, which may comprise a touch screen and/or keyboard, and/or mouse, etc. for interfacing with a user. The data management system 200 may further comprise a timer module 260, operably coupled to an internal data log module 225, which in some examples may be used as a reporting tool for activities performed by the data management system 200. In some examples, the data log module 225 may be used to gather statistics and management information that can be provided to users/clients, for example related to the formation of the trie data structure.

In some examples, the communications controller 240 may also be coupled to application modules 250 or software programs. In one example, the application module(s) 250 may be coupled to a database 245. In some examples, the application modules 250 may provide any system administrator or user the capability to manage data using the trie structure contained in, or operably coupled to, tree/hash engine 265.

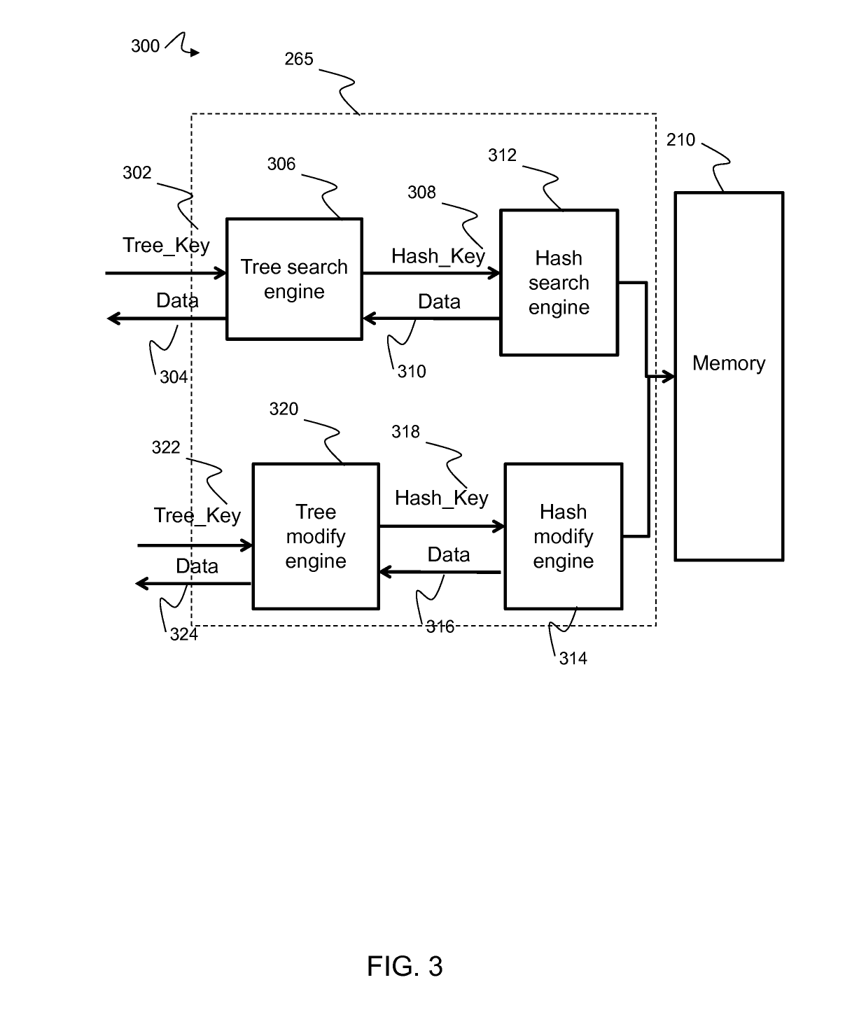

FIG. 3 illustrates a simplified example block diagram 300 of an architecture that uses a trie data structure, according to some examples of the invention. In examples herein described, memory 210 is operably coupled to a tree/hash engine 265 that is used for storing and/or accessing and/or modifying trie structures of data.

In some examples, memory 210 may form part of an integrated circuit, the memory 210 comprising a plurality of interconnected nodes with data stored in a trie data structure wherein at least a portion of said plurality of interconnected nodes is configured as parent nodes and child nodes, wherein at least one child node comprises an identifier of its parent node.

In some examples, tree/hash engine 265 comprises a tree search engine 306 that receives a tree_key 302 to identify the tree or data being searched. The tree search engine 306 generates a hash key 308, based on the tree_key 302, and provides this to a hash search engine 312. In some examples, the hash key may be converted from a node identifier contained in tree_key 302 and child numbers are taken from the tree_key 302. The memory 210 is then accessed to locate the data in the trie data structure using the nodes and unique identifiers described hereafter, as identified by the hash search engine 312. The data is returned to the requestor via paths 310, 304, as shown.

In some examples, to update the trie data structure, tree/hash engine 265 comprises a tree modify engine 320 that receives a tree_key 322 to identify the trie or node to be modified. The tree modify engine 320 generates a hash key 318, based on the tree_key 322, and provides this to a hash modify engine 314. The memory 210 is then accessed to locate the data in the trie data structure to be modified using the nodes and unique identifiers described hereafter, as identified by the hash modify engine 314. The data, such as information on what is the size of the prefix that was found in the trie and data that is associated with that prefix, is returned to the requestor via paths 316, 324, as shown.

In some examples, tree/hash engine 265 may be implemented within an integrated circuit. In some examples tree/hash engine 265 may comprise a processor engine for interfacing with a memory 210 that may comprise a plurality of interconnected nodes with data stored in a trie data structure, wherein at least a portion of said plurality of interconnected nodes is configured as parent nodes and child nodes. The processor engine, for example tree/hash engine 265, may comprise at least one of: a search engine, a modify engine, configured to: receive a tree key identifying a child node; convert the tree key to a hash key; and, for a search engine, access a parent node of the child node identified by the hash key.

In a known implementation of a trie data structure each internal node has a list of pointers that point to the node's children. As the number of children per node is not constant due to dynamic changes in the stored data structure, it is important to know, when reading the node information, how many children the node has. The pointer is then used to access the next child node. Thus, the known technique involves two data structures per node, whereby, say, a left data structure is accessed first and from the left data structure a determination of how many children this node has, and which one exists, is made. Then following this knowledge, the second data structure is accessed in order to obtain the needed pointer to access the next node. In some known implementations, such an approach may involve at least two accesses. In the example implementation, notably no pointers are required, as the child node is accessed instead through a hash table lookup. The removal of a pointer data structure is advantageous in such data management systems.

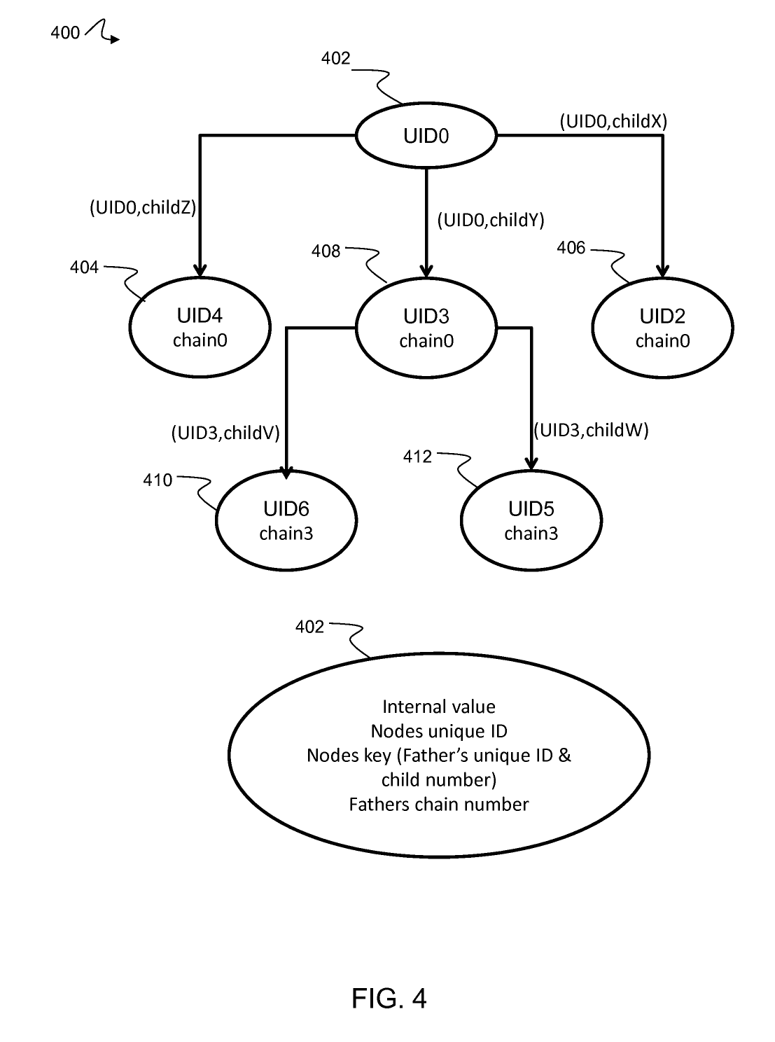

FIG. 4 illustrates an example of how the hash table may be used in order to go down the trie data structure, according to some examples of the invention. When embedding the trie into hash, the trie may be embedded by giving each node that represents an internal node a unique ID. In some examples, this unique ID is the identifier of the father node where each child node also has a number that identifies the child (e.g. ch_number).

To access the child node, the father's unique ID and the child number (UIDx,ch_number) is used as the key to the hash lookup. This information is stored in the child so that the child and the father can be identified. Thus, in this manner, the access to read the pointer in known trie data structures is no longer required.

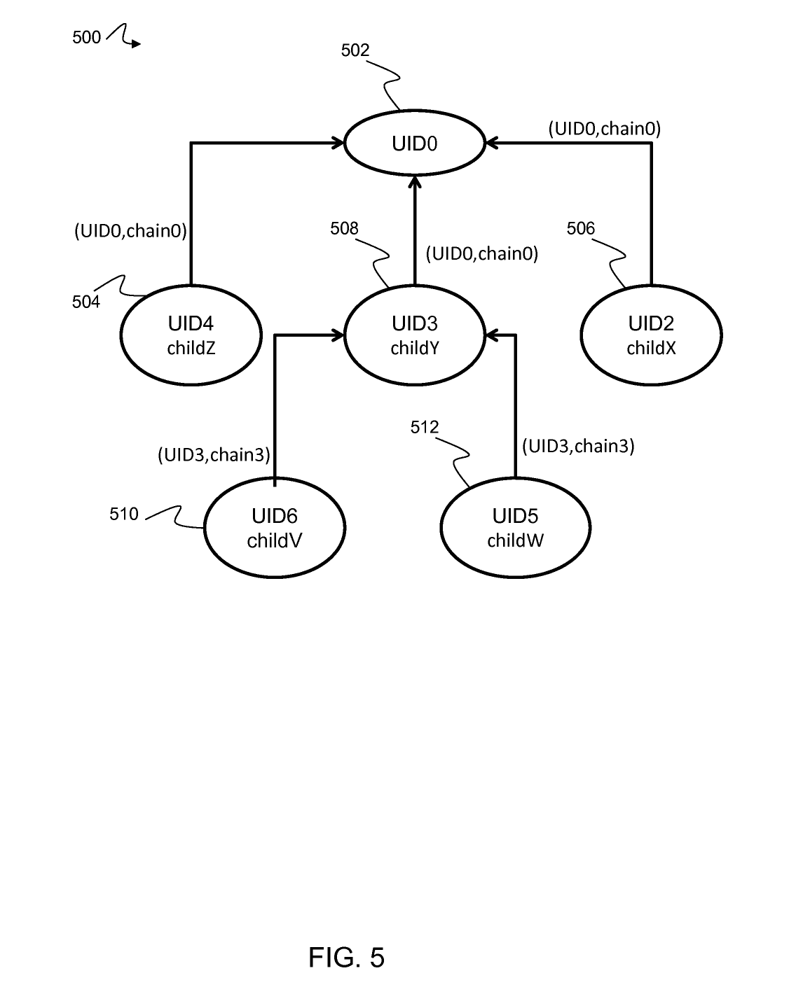

At the highest level of this example trie data structure, the father node 402 comprises a father node's respective unique ID of ‘UID0’. The father node 402 does not contain pointers to each of its children. However, the father node's unique ID as well as the child number points to the respective child node using the hash table lookup. For example, child node 404 with a unique ID of ‘UID4’ is pointed to using a hash table lookup for father ID & child number (i.e. a hash lookup of value UID0,childZ). This example does not include the full information for the pointing up to the father, which is illustrated in FIG. 5.

Similarly, child/father node 408 comprises a unique ID of ‘UID3’, said child/father node 408 being located using a hash lookup value of the father ID & child number (i.e. a hash lookup value of UID0,childY). Similarly child node 406 comprises a unique ID of ‘UID2’ using a pointer of the father ID & child number (i.e. a hash lookup value of UID0,childX).

In this example, child/father node 408 is also shown as being a father node to a further two children, thereby highlighting the trie structure comprising multiple levels of nodes having unique IDs. Thus, for example, child/father node 408 comprises its own unique ID of ‘UID3’ and points to its children with its uniqueID and the respective child number using a hash table lookup. Here, child/father node 408 points to the child's respective unique ID of ‘UID6’, with a hash lookup value that comprises the key (UID3,childV). Similarly, for example, a further child node 412 with a unique ID of ‘UID5’ is pointed at using a hash lookup value that comprises the key (UID3,childW).

In this manner, each node has its own unique ID that identifies itself and provides an ingredient to access its children. Also, the hash lookup value comprising the node's unique ID and the child number points to the child node.

Thus, in some examples, each node comprises an internal value that comprises at least one from a group of:

(i) That node's unique ID;

(ii) A father node's chain number;

(iii) A father node's unique ID; and

(iv) That child node's ID.

FIG. 5 illustrates a different view 500 of the same data structure, and in particular how a hash is used to go up the trie, according to some examples of the invention, whereby the information stored in the child node facilitates a mechanism to access the father node.

For example, a child node 510 with a unique ID of ‘UID6’ has information contained in ‘UID3,chain3’ pointing to the child node's father, notably with the father's respective unique ID of ‘UID3’. Similarly, for example, a further child node 512 with a unique ID of ‘UID5’ comprises the same father related information and points to that child node's same father with the respective unique ID of ‘UID3’.

At the higher levels of the trie data structure, comprising some nodes that act as both father and child, each of the nodes has a unique ID. For example, child node 504 comprises a unique ID of ‘UID4’, and comprises the information ‘UID0,chain0’ pointing to the child node's father node 502 with a unique ID of ‘UID0’. Node 508 is both a father node and a child node and comprises a unique ID of ‘UID3’ and comprises the same father information ‘UID0,chain0’ pointing to the same father node 502 having the unique ID of ‘UID0’. Finally, child node 506 comprises a unique ID of ‘UID2’, and comprises the same father information ‘UID0,chain0’ pointing to the child node's father node 502 with a unique ID of ‘UID0’. Thus, each of these child nodes 504, 506, 508 has information pointing to the child's father node 502 with the father node's respective unique ID of ‘UID0, chain0’, in order for the father to be accessed.

In this manner, each node has its own unique ID that identifies itself as well as hash information allowing a mechanism to reach its father node by use of a special hash lookup. The hash chain number acts as the hash function on a key of the father node. Although the key of the father node is not known, the knowledge of the unique ID of the father enables the lookup to reach the father node. In this manner, each node comprises one or more internal value(s) as illustrated with respect to FIG. 4.

In this manner, a trie data structure may be implemented by embedding its connectivity into a hash table format, together with pre-allocated, uniquely-identified, nodes. In some examples, this facilitates a faster search through the trie data structure. For example, a hash lookup approach as described in the examples will take 1.5 accesses, on average. This value assumes a hash with linear probing collision resolution and 50% load, in comparison to a known method that uses pointers will take two separate accesses. Hence, a gain in performance may be achieved using a hash table approach with unique node IDs.

In some examples, the provision of a hash with pre-allocated, uniquely-identified nodes supports a self-memory management architecture/system. Examples of such improved trie data structures may be useful for any application/product that requires efficient searches, particularly prefix-based searches.

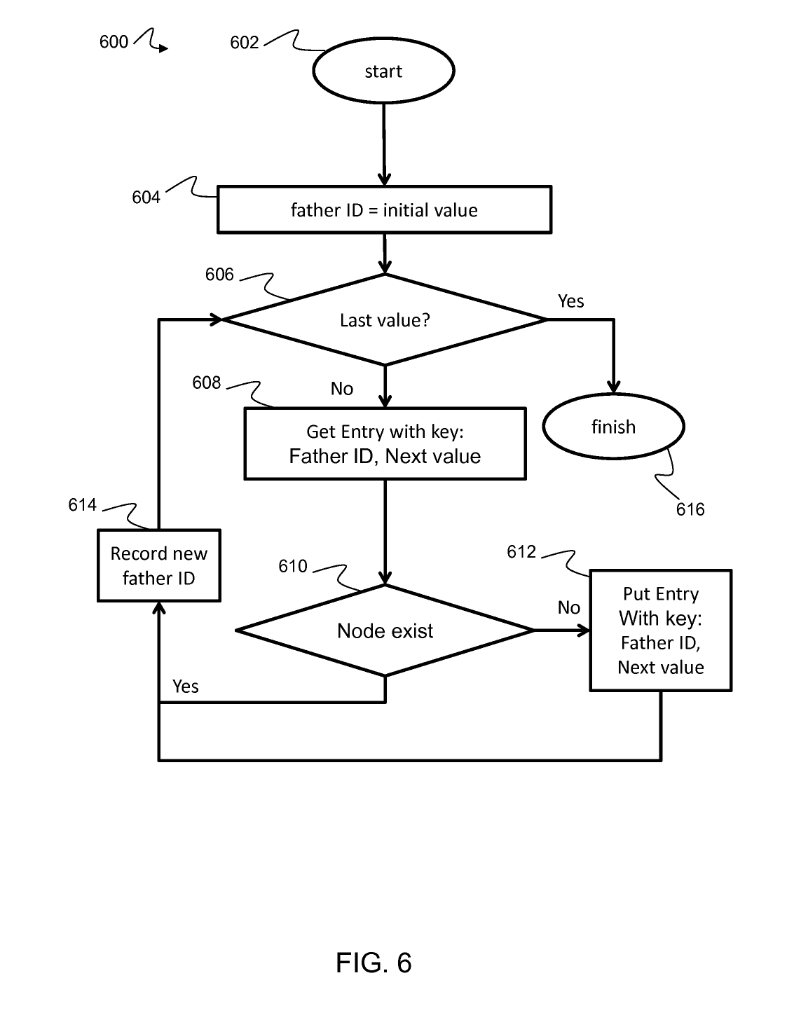

FIG. 6 illustrates an example insert flow chart 600, according to some examples of the invention. The flowchart 600 starts at 602, and at 604 a father node's unique ID is used as an initial value and symbolizes the root of the trie data structure. The process then enters a loop, at 606, with a determination as to whether the current value is the last value. In this initial instance, it is not the last value at 606 and the process moves on to 608 to a standard hash expression of ‘Get entry with key’, where the key in this example notably comprises the father node's unique ID and a next value (e.g. child number). A determination is then made as to whether the node exists at 610. If a node doesn't exist at 610, the process moves to 612 with a standard hash expression of ‘Put entry with key’, where the key comprises the father node's unique ID and the next value (e.g. child ID). The process then moves on to 614. If a node does exist at 610, the process also moves to 614 where a new father ID is recorded and a value of that result made. The process then loops to 606 where the determination is made as to whether the value is the last value. If the loop has completed and the value is the last value at 606, the insert process finishes at 616. In this manner, as new entries are required, a path is created in the trie for the new prefix that needed to be inserted. In some examples, the last inserted entry contains a marker for the end of a prefix and also some application dependent data associated with that prefix.

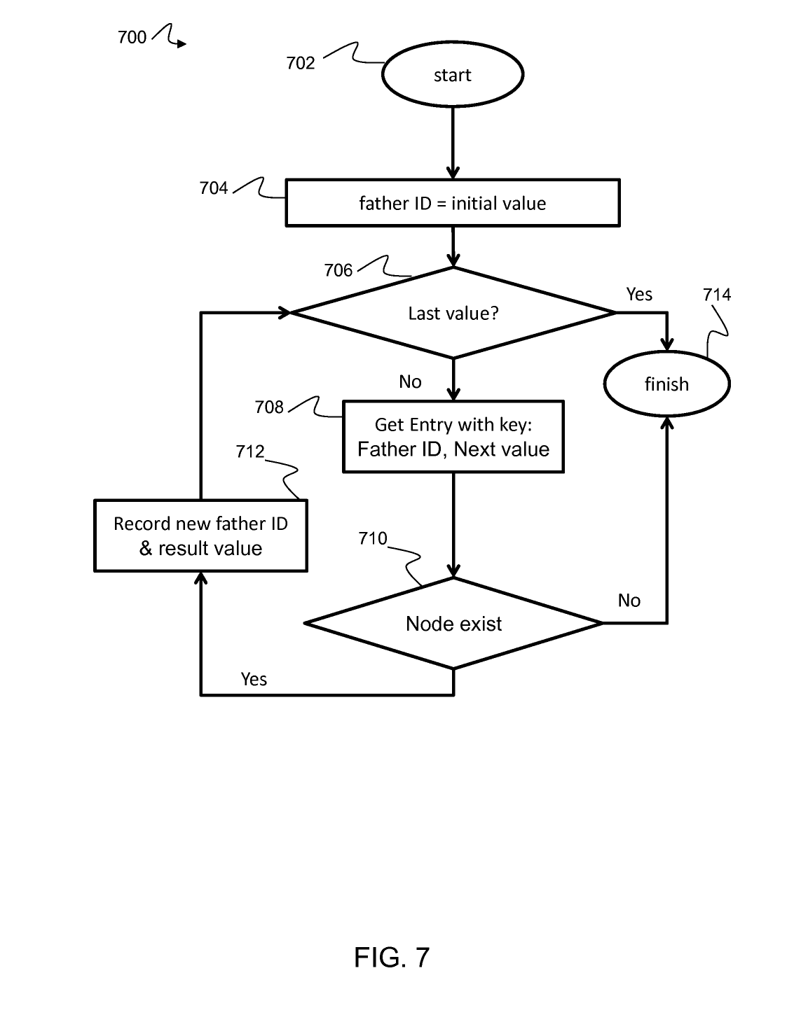

FIG. 7 illustrates an example search flow chart 700, according to some examples of the invention. The aim of the search is to find the longest valid prefix and the data associated with it that is in line with a list of values provided to the search process. The flowchart 700 starts at 702, and at 704 a father node's unique ID is used as an initial value. The process then enters a loop, at 706, with a determination as to whether the current value is the last value. In this initial instance, it is not the last value at 706 and the process moves on to 708 to a standard hash expression of ‘Get entry with key’, where the key in this example notably comprises the father node's unique ID and a next value. A determination is then made as to whether the node exists at 710. If a node doesn't exist at 710, the process finishes at 714. If a node does exist at 710, the process moves to 712 where a new father node's unique ID is recorded and a value of that result made. The result value that is recorded in 712 is the result of the search. Every time a new valid prefix is encountered the result is updated. The process then loops to 706 where the determination is made as to whether the value is the last value. If the loop has completed and the value is the last value at 706, the process finishes at 714.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a tangible and non-transitory computer readable storage medium or transmitted to the computer system via a computer readable transmission medium. All or some of the computer program may be provided on computer readable media permanently, removably or remotely coupled to an information processing system. The tangible and non-transitory computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, electrically erasable programmable read only memory (EEPROM), erasable programmable read only memory (EPROM), read only memory (ROM); ferromagnetic digital memories; MRAM; volatile storage media including registers, buffers or caches, main memory, random access memory (RAM), etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the scope of the invention as set forth in the appended claims and that the claims are not limited to the specific examples described above.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the trie data structure may be contained in one or more of memory 210, database 245 or distinct from both in FIG. 2, and in some examples may be within or external to data management system 200.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected,’ or ‘operably coupled,’ to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit (IC) or within a same device. For example, the tree/hash engine 265 of FIG. 2 may be implemented on a separate IC or may be contained in the same device as the trie data structure. Thus, an integrated circuit may comprise a processor engine for interfacing with a memory comprising a plurality of interconnected nodes with data stored in a trie data structure wherein at least a portion of said plurality of interconnected nodes is configured as parent nodes and child nodes. The processor engine may comprise at least one of: a search engine, a modify engine, configured to: receive a tree key identifying a child node; convert the tree key to a hash key. In the case of a search engine, the processor engine may also access a parent node of the child node identified by the hash key.

Alternatively, the examples may be implemented as any number of separate integrated circuits or separate devices interconnected with each other in a suitable manner. For example, a separate integrated circuit comprising a memory may be provided. The memory may comprise a plurality of interconnected nodes with data stored in a trie data structure wherein at least a portion of said plurality of interconnected nodes is configured as parent nodes and child nodes, wherein at least one child node comprises an identifier of its parent node.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an,’ as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A data management system comprising a trie data structure, the trie data structure comprising a plurality of interconnected nodes wherein at least a portion of said plurality of interconnected nodes is configured as parent nodes and child nodes, wherein at least one child node comprises an identifier of its parent node.

2. The data management system of claim 1 wherein the plurality of interconnected nodes are each identified by a unique identifier.

3. The data management system of claim 1 wherein a unique identifier of a child node comprises at least one from a group of:
a chain number of the parent node;
a child number associated with the child node.

4. The data management system claim 1 wherein a plurality of child nodes comprise a parent unique identifier that identifies the respective parent node of that child node.

5. The data management system of claim 4 wherein the parent unique identifier is stored in a hash lookup table.

6. The data management system of claim 5 wherein a hash lookup key stored in the hash lookup table comprises a unique identifier of a parent node and a child number associated with the child node.

7. The data management system of claim 5 wherein the hash lookup key stored in the hash lookup table comprises a unique identifier of a parent node and a chain number of the parent node.

8. The data management system of claim 5 wherein at least one hash lookup key is stored in each of a plurality of child nodes.

9. The data management system of claim 5 wherein the hash lookup table is a single non-multidimensional hash table comprising a list of hash look up keys to respective father node unique IDs.

10. The data management system of claim 9 wherein the single non-multidimensional hash table is configured to provide a trace back through nodes to a source father node.

11. The data management system of claim 1 further comprising a processor engine operably coupled to the trie data structure and arranged to transform a tree key into a hash key representing a connectivity pointer.

12. The data management system of claim 1 wherein the trie node data structure is a fixed size.

13. An integrated circuit comprising a memory, the memory comprising a plurality of interconnected nodes with data stored in a trie data structure wherein at least a portion of said plurality of interconnected nodes is configured as parent nodes and child nodes, wherein at least one child node comprises an identifier of its parent node.

14. An integrated circuit comprising a processor engine for interfacing with a memory comprising a plurality of interconnected nodes with data stored in a trie data structure wherein at least a portion of said plurality of interconnected nodes is configured as parent nodes and child nodes, the processor engine comprising at least one of: a search engine, a modify engine, configured to:
receive a tree key identifying a child node;
convert the tree key to a hash key; and
for a search engine access a parent node of the child node identified by the hash key.

15. A method of accessing data in a trie data structure, wherein the trie data structure comprises a plurality of interconnected nodes wherein at least a portion of said plurality of interconnected nodes is configured as parent nodes and child nodes, the method comprising:
accessing a child node;
obtaining an identifier of the accessed child node; and
determining from the accessed child node an identifier of a parent node of the accessed child node.

16. The method of claim 15 wherein the identifier is a unique identifier to the accessed child node.

17. The method of claim 15 wherein the unique identifier of the accessed child node further comprises at least one from a group of:
a chain number of the parent node;
a child number associated with the child node.

18. The method of claim 15 further comprising storing a key in a hash lookup table, wherein the key identifies the respective parent node of that child node.

19. The method of claim 18 wherein the method further comprises accessing the parent node using the key from the hash lookup table and a present key hash value.

20. The method of claim 19 wherein the method further comprises hash lookup key stored in the hash lookup table comprises a unique identifier of a parent node and a child number associated with the child node.
